(19) United States
(12) Patent Application Publication
(10) Pub. No.: US 2012/0110184 A1
(43) Pub. Date: May 3, 2012

(54) PHYSICAL LAYER PHOTONIC PROTOCOL SWITCH

(75) Inventors: Brian L. Uhlhorn, St. Paul, MN (US); Howard J. Schantz, Inver Grove Heights, MN (US)

(73) Assignee: LOCKHEED MARTIN CORPORATION, Bethesda, MD (US)

(21) Appl. No.: 12/915,505

(22) Filed: Oct. 29, 2010

(51) Int. Cl. G06F 15/16; H04L 29/06

(52) U.S. Cl. 709/226; 726/1

(57) ABSTRACT

A physical layer photonic protocol switch (PLPPS) that is protocol independent and switches at the optical signal level. Computing subsystem resources are linked to the PLPPS and are grouped into one or more logical system topologies. If needed, additional computing subsystem resources can be allocated to the logical system topology, during runtime. The PLPPS provides the ability to dynamically allocate computing subsystem resources to specific computing enclaves. The PLPPS manages the configuration of and controls access to the computing subsystem resources. Computing resources can then be assigned to specific logical system topologies and additional computing subsystem resources are able to be shared, added or removed, from other logical system topologies, as needs fluctuate. This physical layer switch architecture creates a dynamic computing infrastructure allowing for the sharing of a single computing subsystem resource amongst two or more logical system topologies.

### FIELD

The disclosure relates to a physical layer photonic protocol switch (PLPPS) that is protocol independent and switches at the optical signal level.

### BACKGROUND

A physical network is a system of devices or resources that communicate via cabling, modems, routers, or other hardware. The resources are physically connected to a computing infrastructure to form a logical system topology and are managed independently of any other logical system topology with a distinct separation of responsibilities, different security levels and different rules in each topology. Each logical system topology is seen as a private area where information is not openly shared with other topologies and is isolated from other topologies. Each logical system topology can be seen as having its own security classification that may be different than the security classification of any other logical system topology. In order to share or reassign computing subsystem resources between logical system topologies, the subsystem resources must be manually unplugged from a network switch of a first logical system topology and then manually plugged into a network switch of a second logical system topology.

In a typical scenario of secure interconnect capability, as shown in FIG. 1A, some physical networks may include, for example, more than one logical system topology (LST) or enclave or form part of an extended network which incorporates one or more LST's, whose network switches are linked to each other through a guard or firewall. The guard is in place to control the protocol rules, to filter certain traffic between the systems, and to prevent secure information from being shared between the LST's. For example, in an office system, the human resources department and the accounting department share the same extended network which contains general computing functions, but each department has their own logical system topology that is isolated from other logical system topologies. Therefore, the accounting department does not have access to the human resource logical system topology which contains personal information regarding the employees. Additionally, the processors in the human resources department are not available for the accounting departments use and are not able to be reassigned to the accounting department without manually unplugging and moving the processors.

As illustrated in FIG. 1B, in order to provide additional processing capabilities to LST #1, Processor 4 is manually unplugged from the switch of LST #2 and is then manually plugged into the switch of LST #1. This limits the use of Processor 4 to one LST at a time.

Therefore, without manual reconfiguration and sanitization of the equipment, the mission system equipment or subsystem resources cannot be shared between multiple security classification levels. For example, if users of two separate security classifications require the use of a processor, then two separate processors would normally need to be provided.

### SUMMARY

is A physical layer photonic protocol switch (PLPPS) that is protocol independent and switches at the optical signal level is described herein. Computing subsystem resources are connected to the PLPPS and are able to be allocated or shared with one or more logical system topologies (LST) or enclaves of differing security levels. Embedded within the PLPPS is a configuration policy manager and controller having a topology policy library that contains the approved or accredited list of logical system topologies permitted access to the system. During runtime additional computing subsystem resources can be allocated to a specific logical system topology or shared amongst a plurality of logical system topologies, when needed.

The PLPPS provides the ability to dynamically allocate computing subsystem resources to specific computing enclaves or logical system topologies without the need to manually reconfigure the connection to the PLPPS. The PLPPS manages the configuration of and controls access to the computing subsystem resources. Computing subsystem resources can then be assigned to specific logical system topologies and additional computing subsystem resources are able to be shared, added or removed, from other logical system topologies, as needs fluctuate. This physical layer switch architecture creates a dynamic computing infrastructure allowing for the sharing of a single computing subsystem resource amongst two or more logical system topologies of differing security classification levels while performing high-speed data manipulation, all while maintaining channel separation and security separation.

The PLPPS is a dynamic computing system that is advantageous in that allocation of computing subsystem resources is done without the physical or manual manipulation of the computing subsystem resources. This architecture driven allocation is less time consuming than the physical act of unplugging and plugging in a computing subsystem resource or a user inputting data. Another advantage is that more processes are able to be run with fewer separate subsystem resources. Additionally, the space or footprint required to house the various subsystem resources is reduced. The reduced footprint also is helpful in supporting multiple missions from limited space environments.

The PLPPS can also provide a secure computing environment where the separation of data between different security classifications is essential. In a military environment, this allows for the sharing of mission system equipment across multiple security sensitivity levels and enables a reduction in size, weight and power (SWaP) of embedded mission system equipment applications. Different security enclaves can be created without additional hardware resources and under-utilized subsystem resources can be reassigned to other security enclaves.

Applications of a PLPPS include public and private entities. Example applications of a PLPPS include, but are not limited to: space constrained systems, where subsystem resources need to be shared amongst several software applications; applications which require subsystem resources to be reconfigured or redistributed during the mission; distributed computing systems; and ad hoc computing systems. Users can comprise commercial or public enterprises, for example, businesses involved in processing of payroll, insurance companies, banks, accounting firms, private security, police and fire departments, Department of Defense, and the military. In essence, users of a dynamic computing system could comprise any entity that may require more than one user system, especially where the user systems are of different security levels.

One advantage of the dynamic nature of the PLPPS infrastructure allows for better subsystem resource sharing. In space constrained systems, such as a Navy surface ship or submarine, subsystem resources may need to be shared amongst several software applications during the mission, but the information contained within those subsystem resources is not to be shared. The PLPPS ensures that the information remains separated by providing both a strong port-to-port separation and an ability to securely block specific ports from receiving unauthorized information flows through the protocol switch.

An additional advantage of the PLPPS dynamic enclave computing system allows for switching at a physical layer of a network stack, which is protocol independent. Currently, most computing infrastructures in Department of Defense (DoD) platforms are fixed to the underlying local area network (LAN). Therefore, with the PLPPS, the potential is higher to get security certified for DoD platform applications than applications that require commercial-off-the-shelf (COTS) virtual local area networks (VLAN) or COTS VLAN.

### DRAWINGS

FIG. 1A illustrates a typical scenario of computing architecture containing a guard between logical system topologies or security enclaves.

FIG. 1B illustrates a typical scenario of computing architecture containing a guard between logical system topologies or security enclaves and the manual reconfiguration or the reassignment of a processor.

FIG. 2 illustrates the new computing architecture approach using the PLPPS system.

FIG. 3A is a diagram of a prior art MEMS device.

FIG. 3B is an illustration of a prior art MEMS device with a micro-mirror array.

FIG. 3C is an illustration of a prior art MEMS device with piezoelectric beam steering.

FIG. 4 illustrates a PLPPS system.

FIG. 5 illustrates the configuration policy manager and controller (CPMC) and the CPMC function modules.

FIG. 6 illustrates exemplary logical system topologies and a PLPPS system.

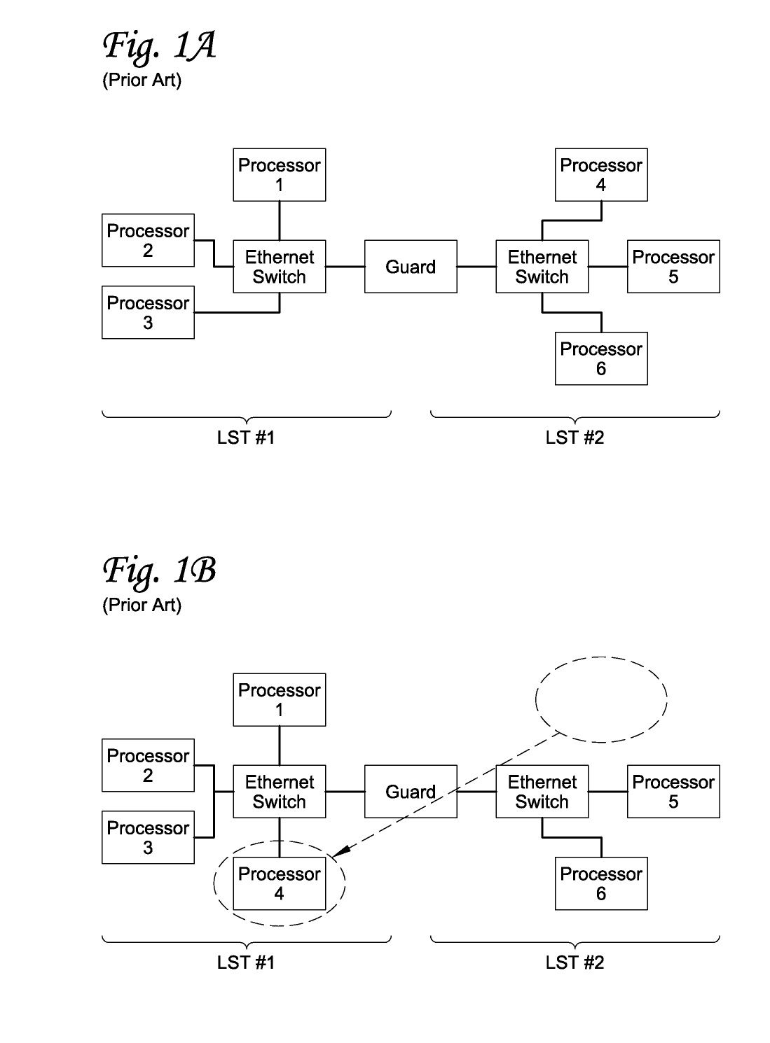

### DETAILED DESCRIPTION

A physical layer photonic protocol switch (PLPPS) system that is protocol independent and switches at the optical signal level is described herein. Computing subsystem resources are connected to the PLPPS and are able to be allocated or shared amongst one or more logical system topologies while maintaining the separation amongst channels and security levels. Embedded within the PLPPS is a configuration policy manager and controller having a topology library that contains the approved or accredited list of logical system topologies permitted access to the PLPPS and the security classification. If needed, additional computing subsystem resources can be allocated to the logical system topology, during runtime.

The PLPPS is configured to dynamically allocate computing subsystem resources to specific computing enclaves or logical system topologies. The PLPPS is configured to manage the configuration of and control access to the computing subsystem resources. Computing subsystem resources can then be assigned to specific logical system topologies and additional computing subsystem resources are able to be shared, added or removed, from other logical system topologies, as needs fluctuate. The physical layer switch architecture of the PLPPS creates a dynamic computing infrastructure further allowing for the sharing of a single computing subsystem resource amongst two or more logical system topologies while performing high-speed data manipulation. The physical layer switch architecture separates the different channels and allows some channels to flow while blocking others.

This application refers to a computing system and is intended to broadly cover the class of hardware architectures and software used for computing. Computing can mean the activity of using computer technology, whether it is computer hardware and/or software. For example, the computing system can comprise some form of network, regardless of whether that network is printed onto a circuit board or made up of linked devices and cables. And the computing system processes are able to be interconnected via some form of communication system, comprising equipment or cabling. However, this application is also intended to encompass computer hardware architecture and software that does not perform mathematical and logical operations.

Computing is also intended to encompass activities requiring or benefiting from computers. Thus, computing encompasses hardware and software systems for the purposes of, for example, processing, structuring, and managing various kinds of information, doing scientific studies using computers, making computer systems behave intelligently, creating and using communications and entertainment media, finding and gathering information relevant to any particular purpose, capturing data from sensors, e.g. an ethernet enable camera, and so on.

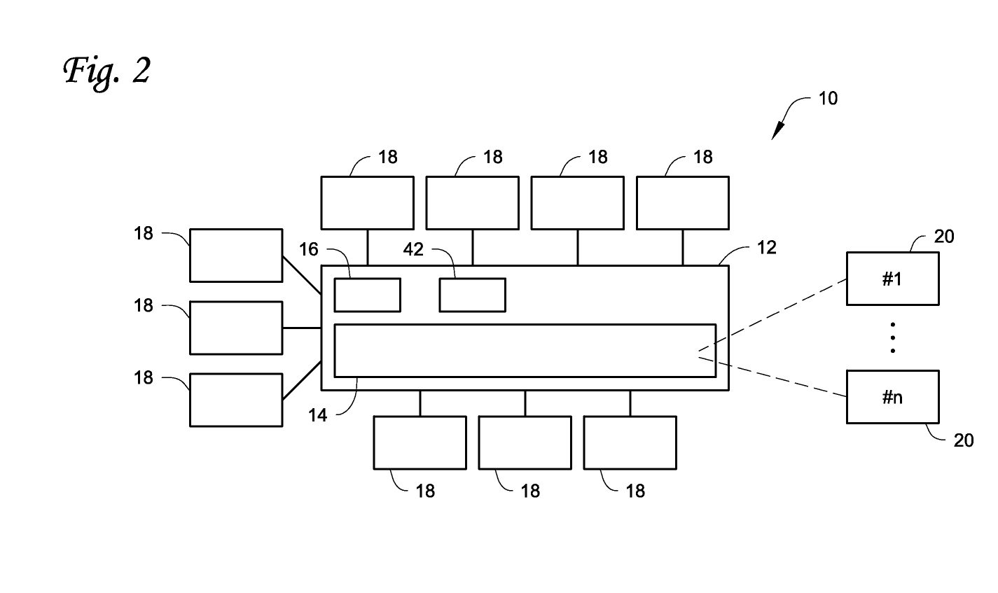

With reference to FIG. 2, a PLPPS system 10 is illustrated as implementing at least one protocol processor 16, at least one optical blocker 42, a configuration policy manager and controller (CPMC) 14, and at least one or, for example, a plurality of computing subsystem resources 18 in communication with the PLPPS 12. The CPMC 14 has a topology library containing the approved or accredited list of logical system topologies 20 that may access the system to include the security classifications. Logical system topology 20 data is thus downloaded or transferred to the CPMC 14 to generate the topology library. The computing subsystem resources can include, but are not limited to, processors, guards, Ethernet switches, etc. The protocol processor 16 can be configured to allocate at least one of the computing subsystem resources 18 so that a requesting logical system topology 20 has access to the computing subsystem resource 18.

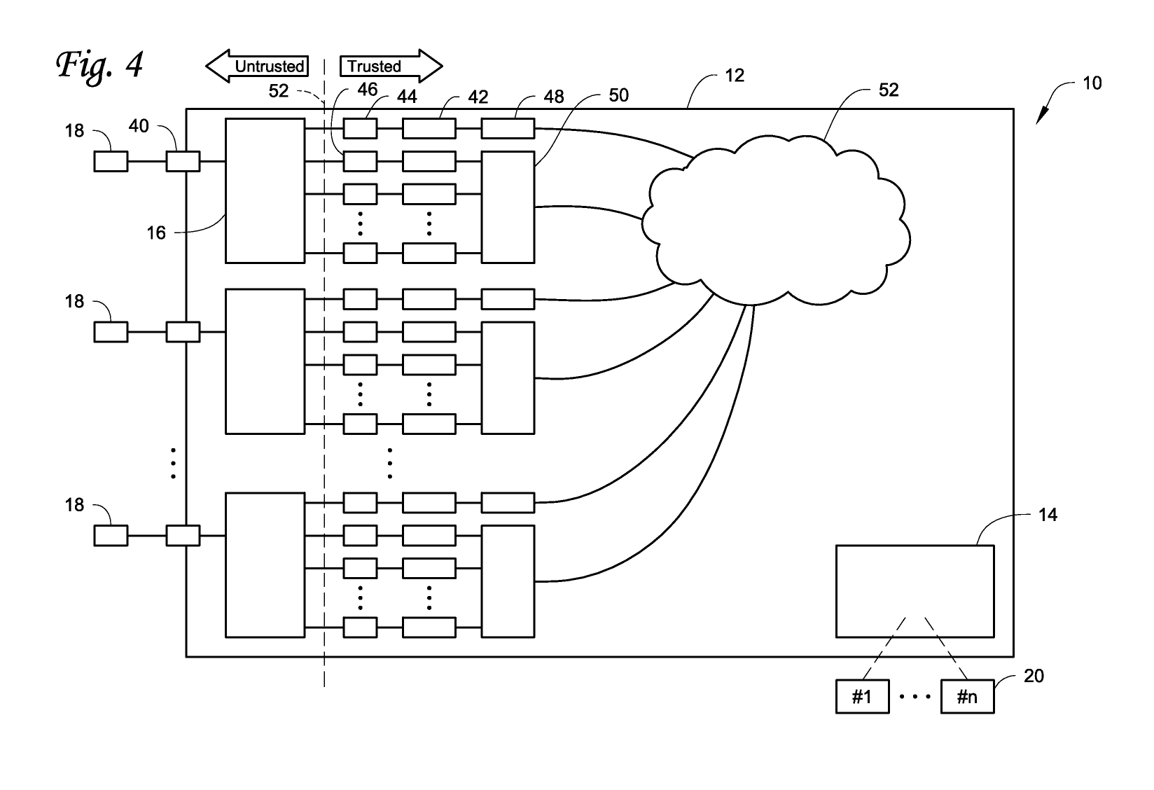

The PLPPS system 10 is based on a conventional optical wavelength division multiplexing (WDM) star/coupler architecture. Thus, for networks that support multi-enclave information, the PLPPS system 10 implementation provides a secure network that protects each logical system topology 20 by providing a strong port-to-port separation and an ability to securely block specific ports from receiving unauthorized information flows. The PLPPS system 10 creates a plane of trust 52 (see FIG. 4) that is well controlled.

It is to be understood that even though the PLPPS 12 is described herein as being optical based, it is possible that a non-optical system or electronic patch panel can be used that could perform high-speed data manipulation and assign and share subsystem resources 18 as described herein.

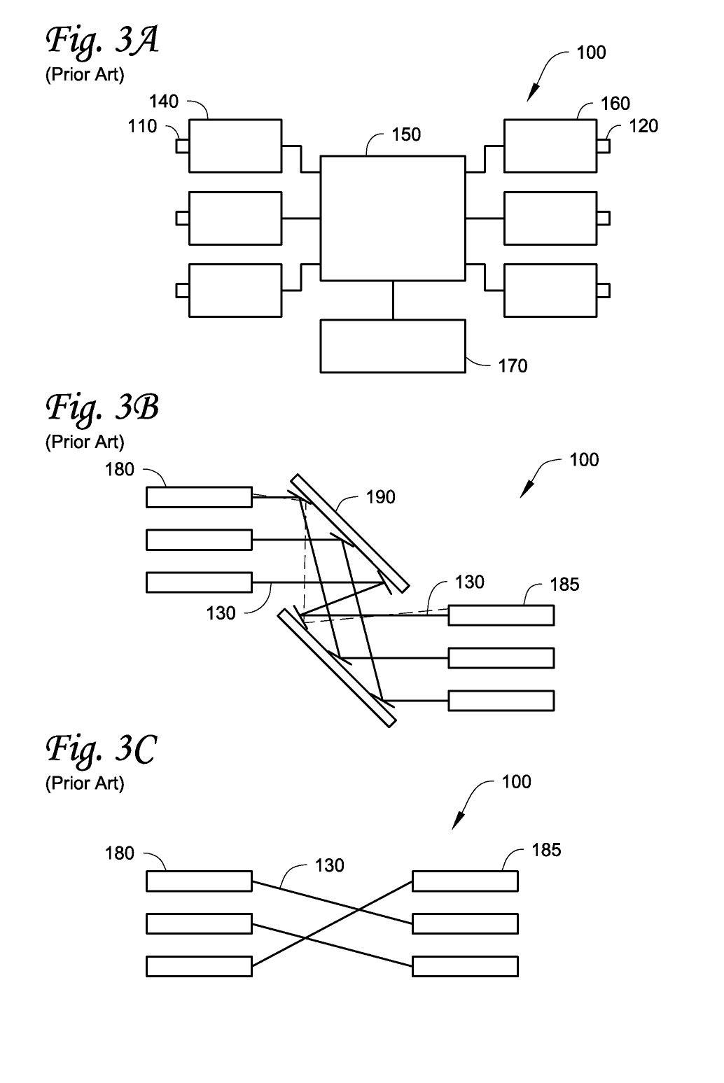

The PLPPS system 10 differs from current optical switches on the market, e.g. micro-electro-mechanical systems (MEMS), as illustrated in FIGS. 3A to 3C. A MEMS device 100 is an optical switch. An optical signal is received at an input port 110 and is directed to an output port 120. The MEMS device 100 allows for reconfiguration so that the output port 120 can be changed depending on network needs. The topology of the MEMS device 100 is simply point-to-point communication and does not allow for a broadcast topology as in the PLPPS system 10. In addition, the optical signal 130 that is input to the MEMS device 100 is the same signal that is output. This differs from the PLPPS system 10 where the optical signal wavelengths are configured so that they are separated and some are allowed to flow while others are blocked.

FIG. 3A is a system diagram of the MEMS device 100. The input ports 110 can be connected to electro-optic converters 140 which are in turn connected to a reconfigurable MEMS switch 150. The optical signal is input to the MEMS switch 150 and is output to an optic-electro convertor 160 and exits the MEMS device 100 at the output port 120. The MEMS switch 150 is controlled by a switch manager 170 that processes requests from nodes and issues commands to switch the path of the optical signal.

FIG. 3B highlights the technology of the MEMS device 100 with a micro-mirror array and its operational aspects. Input passive collimators 180 direct the optical signal 130 to a mirror array 190 which redirects the optical signal 130 to output passive collimators 185. Adjustment of the mirror arrays 190 perform switching or optical blocking. It is to be noted that the optical signal 130 is not altered, only redirected or blocked in its entirety.

FIG. 3C highlights the technology of a MEMS device 100 with piezoelectric beam steering and its operational aspects. Input passive collimators 180 direct the optical signal 130 directly to output passive collimators 185. It is to be noted that the optical signal 130 is not altered, only redirected or blocked in its entirely.

One embodiment of the a PLPPS system 10 is shown in more detail in FIG. 4. This embodiment includes a PLPPS 12, a CPMC 14, a plurality of the protocol processors 16, ports 40, optical blockers 42, optical transmitters 44, optical receivers 46, filters 48, demultiplexers 50 and a passive optical star (POS) 52. As part of the PLPPS system 10, components can include, but are not limited to, computing subsystem resources 18 and logical system topologies 20. It is to be understood that the PLPPS system 10 can include one or any number of the components as shown and that the configuration can be altered as required.

The CPMC 14 is connected to the optical blockers 42 (the connection is not shown in FIG. 4). Logical system topologies 20 are downloaded to the CPMC 14 by transference of data via, for example, a wireless, wired, or data storage device. This does not limit the transference of data by the examples given. Data can be transferred using any known or yet to be known method of data transfer. Computing subsystem resources 18 are connected to the PLPPS 12 through the ports 40.

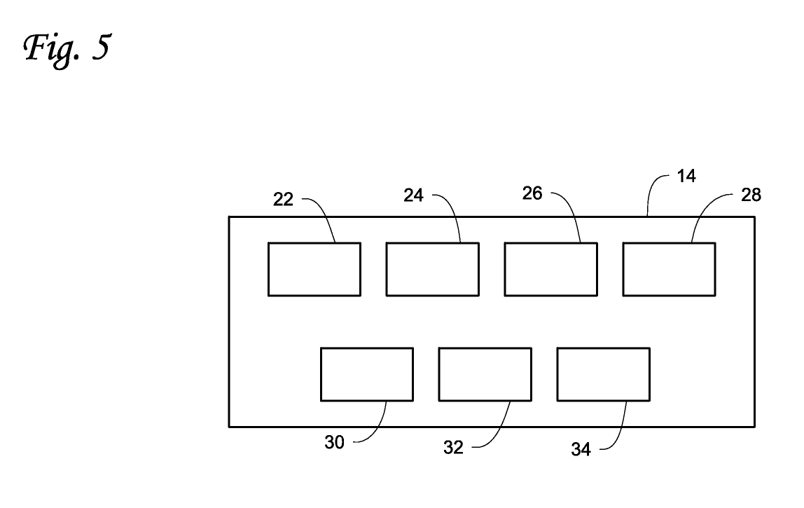

The CPMC 14 is a computing device that manages the policies of the logical system topologies 20 and controls and manages the functional elements of the PLPPS 12. The CPMC 14 manages the configuration of the optical signal and gives permissions to allow certain wavelengths while blocking other wavelengths. The CPMC 14 is responsible for managing and controlling the optical blocker 42, thereby effectively controlling and managing the configuration of the subsystem resources 18. As shown in FIG. 5, the functional elements of the CPMC 14 can include, but are not limited to, a topology policy library module 22, a failover control module 24, a diagnostics module 26, an external management and control interface 28, an audit function module 30, a control module for the internal optics transmit function 32, and a control module for the internal optics receive function 34. The modules can be implemented either by hardware or by software. The communication framework of the modules could be protocol and software language independent.

The topology policy library 22 is an information library based on data structures that have been loaded. The data structures contain the approved or accredited collection of logical system topologies 20 that the PLPPS 12 can support and the logical system topologies 20 that are permitted to access the PLPPS 12 and access and use the subsystem resources 18. The topology policy library 22 determines the connectivity, through the optical blocker 42, between the various subsystem resources 18 and the PLPPS 12 by providing information to the optical blocker 42 on which optical wavelengths or signals to allow or block. This is accomplished while maintaining the proper security classification levels, maintaining the plane of trust 52 and preventing the cross-over of information between the logical system topologies 20 of differing security classification levels. The topology policy library 22 can only be accessed and modified by users with the proper credentials and password access, but can be modified while in use, if needed.

The failover control module 24 controls the reconfiguration of the system in the event of a system failure. The diagnostics module 26 performs the power up and runtime Built-In-Test. The external management and control interface module 28 can be browser based. The interface module 28 can be an external interface consisting of COTS protocol, e.g. a port and an Ethernet switch. The audit module 30 collects and records all security critical events.

Allowance or blockage of the various wavelengths is accomplished through the control modules for the internal optics transmit and receive functions 32, 34, which is in essence an optical filter which separates the different channels.

The CPMC 14 is linked to the optical blocker 42 via a wired connection or a wireless connection. The wired connection may include, for example, fiber optic, coaxial, or twisted pair structured cabling. The wireless connection may include, for example, infrared radiation, microwave, or radio waves through a medium like air and may include, for example, narrowband, broadband, or circuit/packet data. However, any type of connection to link the optical blocker 42 and the CPMC 14 so that they can communicate can be used.

One or more protocol processors 16 are provided. The protocol processor 16 is an electronic device that makes it possible to interconnect the various subsystem resources 18 to specific transmission paths based on input from the CPMC 14. The protocol processor 16 provides Layer 2 and higher Protocol switch and protocol functions including MAC protocol, discovery protocol, packet switching/routing, etc. The protocol processor 16 adds an abstraction layer between the cable plant and the computing resources and provides the electrical interface to the optical transmitters 44 and receivers 46.

One or more ports 40 are provided on the PLPPS 12. The ports 40 allow the computing subsystem resources 18 to connect to the PLPPS 12 in order to transmit and receive data to and from the PLPPS 12. The port 40 can be a wired or a wireless connection. The wireless connection can be radio frequency, infrared light, laser light, visible light, acoustic energy or any other means available to transfer information without the use of wires. The wired connection can include RS-232, USB, Category 5 Ethernet cable, or any other type of connection that physically connects the computing subsystem resources 18 to the PLPPS 12 and is able to transmit information.

One or more optical blockers 42 are provided. The optical blockers 42 implement the logical system topology 20 configuration policy by configuring which wavelengths to allow and which wavelengths to block. The optical blocker 42 is protocol independent and does not inspect incoming traffic or make routing decisions. The optical blocker 42 is controlled by and instructed by the CPMC 14 as to which wavelengths are to be transmitted and which wavelengths are to be blocked.

One or more optical transmitters 44 and receivers 46 are provided. A optical transmitter 44 and receiver 46 uses fiber optic technology to efficiently send and receive data, respectively, audio, and video at high speed data rates over with minimal signal skew. Transmitters 44 convert electrical signals into optical signals and receivers 46 convert optical signals into electrical signals.

One or more optical filters 48 are provided. Optical filters 48 are designed to pass specific wavelengths and reject others. The optical filters 48 can be either low-pass or high-pass filters but are most likely band-pass filters. A low-pass fiber optic filter allows only shorter wavelengths of light to pass through the filter 48, while a high-pass fiber optic filter allows only the longer wavelengths to pass through. A band-pass optical filter allows only a narrow range of wavelengths to pass through. Fiber optics filters 48 can be fine-tuned to select very narrow wavelength ranges.

One or more demultiplexers 50 are provided. A demultiplexer 50 receives multiple signals that have been transmitted on one line and then decodes these single line signals into separate multiple signals. The demultiplexer 50 is able to transmit the individual data signals from multiple logical system topologies 20 simultaneously over one communications medium while maintaining separation and security of the data. The demultiplexer 50 supports the implementation of the logical system topology 20 configuration policy by separating the different channels for the optical blockers 42.

The passive optical star (POS) 52 is a passive platform for implementing the optical network by providing broadcast capability. Through Wavelength Division Multiplexing (WDM), a large bandwidth of optical fiber can be divided into a set of high-speed logical channels. One wavelength can be provided to the POS 52 and multiple wavelengths can be distributed. All WDM wavelengths are combined on the POS 52.

The computing subsystem resources 18 comprise any component that can be attached to a computing network including, but not limited to, processors, external communication devices, internal communication devices, storage devices, down graders, sensors, displays, network switches, guards, printers, servers, scanners, voice over IP systems, workstations, personal computers, etc. The subsystem resources 18 are linked to the PLPPS 12 via a wired connection or a wireless connection via a port 40. The wired connection may include, for example, fiber optic, coaxial, or twisted pair structured cabling. The wireless connection may include, for example, infrared radiation, microwave, or radio waves through a medium like air and may include, for example, narrowband, broadband, or circuit/packet data. However, any type of connection to link the PLPPS 12 and the subsystem resources 18 so that they can communicate can be used.

For example, one type of subsystem resource 18 can be a processor. A processor is an electronic circuit that can execute computer programs and are made for one or many purposes. This includes, but is not limited to, central processing units (CPU) and microprocessors. There can be any number or no processors in the PLPPS system 10.

Another type of subsystem resource 18 can be a storage device. A storage device is any device for recording or storing information or data. A storage device may hold information, process information, or both. Storage devices include, but are not limited to, random access memory (RAM), optical disks, floppy disks, USB flash drives, hard disk drives, magnetic tape, film, punch cards, and video tapes. There can be any number or no storage devices in the PLPPS system 10.

Another type of subsystem resource 18 can be a communication device. A communication device can be on- or off-platform or external/internal. The communication device can be, for example, wide-band, satellite communications, radio communications, or a terminal. There can be any number or no communication devices in the PLPPS system 10.

Another type of subsystem resource 18 can be a sensor. The sensor can be, but is not limited to, a camera, surveillance radar, electronic support measures (ESM), identify friend or foe (IFF) or automatic identification system (AIS). There can be any number or no sensors in the PLPPS system 10.

Each type of subsystem resource 18 could be comprised of a plurality of that type of resource or a combination of any type of subsystem resource 18. However, each type of subsystem resource 18 could be none or any number of subsystem resources 18.

A logical system topology 20 may be isolated, maintained separate, or private, from other logical system topologies 20 and may be allocated to perform specific processing activities or be allocated to specific computing groups. For example, one logical system topology 20 can be a surveillance data distribution topology while a separate topology can be a communications relay.

A logical system topology's 20 information may be kept private and not shared with other logical system topologies 20. Another example may allow for sharing of information, in whole or in part, between logical system topologies 20. Additionally, a logical system topology 20 may be configured as a subsystem resource 18 and allocated to a separate logical system topology 20.

The logical system topologies 20 data is downloaded or transferred to the CPMC 14 topology library 22. The transfer of data can be accomplished by a wired connection, a wireless connection, via a data storage device, e.g., a thumb drive, hard drive, magnetic tape, optical disk, or by any known or yet to be known method of data transfer. The wired connection may include, for example, fiber optic, coaxial, or twisted pair structured cabling. The wireless connection may include, for example, infrared radiation, microwave, or radio waves through a medium like air and may include, for example, narrowband, broadband, or circuit/packet data.

In the PLPPS system 10, a logical system topology 20 can acquire additional resources 18. The CPMC 14 sends messages using application software to instruct the optical blocker 42 to allocate subsystem resources 18 to specific logical system topologies 20. The CPMC 14 has knowledge, by function modules, of all subsystem resources 18, where each subsystem resource 18 is allocated and whether the subsystem resource 18 is in use or is available or can be shared. The CPMC 14 is able to allocate the subsystem resources 18 to specific logical system topologies 20 and is able to add or reduce subsystem resources 18 to the logical system topologies 20 as needed by instructing the optical blocker 42 to configure wavelengths to allow or block specific channels.

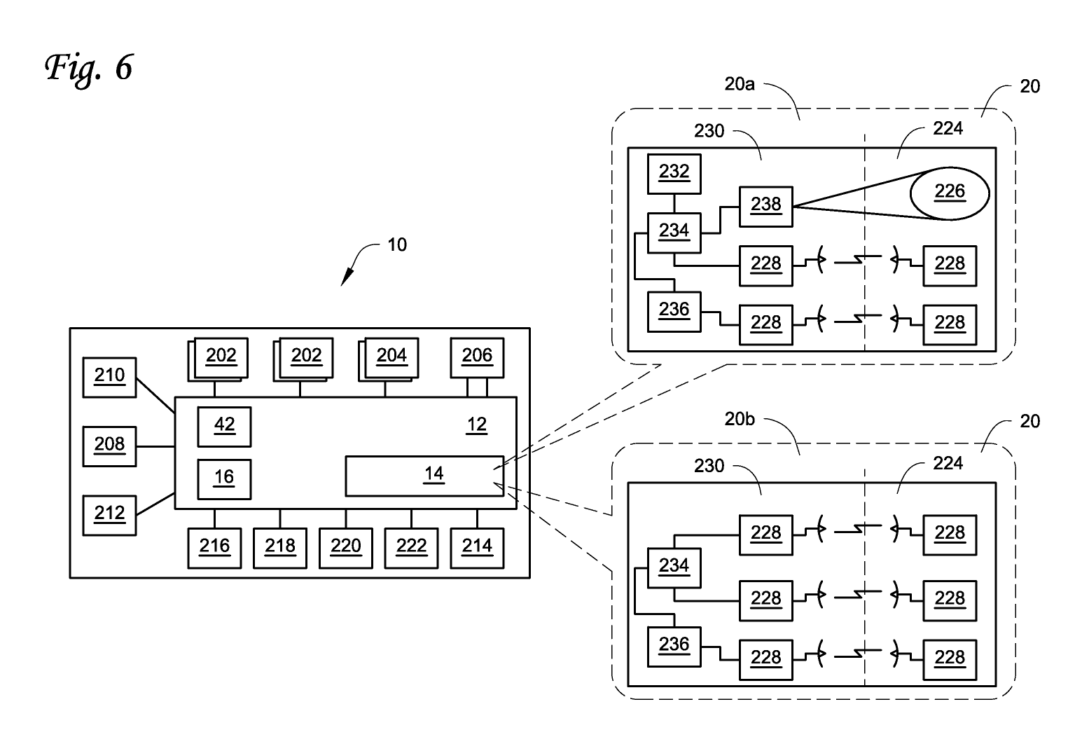

An example of how a subsystem resource 18 is assigned to a specific logical system topology 20 in the PLPPS system 10 follows and is illustrated in FIG. 6. The physical configuration of the PLPPS system 10 comprises the PLPPS switch 12 with at least one protocol processor 16, at least one optical blocker 42 and the topology library 14. Computing subsystem resources connected to the PLPPS 12 can include, as in this example, processors 202, storage 204, a down grader 206, wide band communications 208, a UHF/VHF radio 210, a CDL terminal 212, an NBSC terminal 214, and sensors, including an electro-optic infrared camera 216, surveillance radar 218, electronic counter measures (ESM) 220, and an automatic identification system (AIS) 222.

Shown in FIG. 6 are two logical system topologies 20. Any number of logical system topologies 20 can be provided and the logical system topologies 20 can be comprised of any number of components to perform the same or different functions. One example of a logical system topology 20 is a surveillance data distribution capability with theater topology 20a used in a military setting in which the theater 224 comprises a surveillance spot 226, and any number of military radios 228. The theater 224 is in communication with an Unmanned Aerial System (UAS) Infrastructure Topology 230 where the UAS Infrastructure Topology 230 comprises a processor 232, an Ethernet switch 234, a down grader 236, an electro-optic infrared camera 238, and any number of military radios 228.

The second logical system topology 20 is a communications relay capability within theater topology 20b used in a military setting in which the theater 224 comprises any number of military radios 228. The theater 224 is in communication with an Unmanned Aerial System (UAS) Infrastructure Topology 230 where the UAS Infrastructure Topololgy 230 consists of an Ethernet switch 234, a down grader 236, and any number of military radios 228.

The logical system topology 20, for example, the surveillance data distribution topology 20a, is in contact with the PLPPS system 10 via the topology library 22. As the logical system topology 20a collects and processes data, it is realized by the topology 20a that additional processing capability is required. A request is sent from the logical system topology 20a to the CPMC 14 requesting a processor 202. The CPMC 14 receives the request and determines, per its approved list as to whether the specific logical system topology 20a is permitted access to the system and a processor 202.

Upon verification of accessibility, the optical blocker 42 is instructed by the CPMC 14 to the unblock state to allocate a processor 202 to the requesting logical system topology 20a. A network path is then established so that the logical system topology 20a has access to the processor 202. Upon completion of the task, when the logical system topology 20a no longer has a need for the additional processing capability, the CPMC 14 closes the optical blocker 42 and the processor 202 is no longer available to the logical system topology 20a but is available to and can be reassigned to other logical system topologies 20 as needed. The allocation of the subsystem resources 18 are platform and mission dependent so that in some operations the subsystem resources 18 will require sanitization and in other operations no sanitization is required. For example, if the processor 202 is provided to a logical system topology 20 up in security level from its previous assignment, no sanitization may be necessary. But, if the processor 202 is provided to a logical system topology 20 down in security level, sanitization may be necessary.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A physical layer protocol switch, comprising:
at least one optical blocker;
at least one protocol processor; and
a configuration policy manager and controller connected to the optical blocker that manages and controls the optical blocker, the configuration policy manager and controller has a topology library containing a list of approved topologies.

2. The physical layer protocol switch of claim 1, wherein the physical layer protocol switch is configured to switch at an optical signal level.

3. The physical layer protocol switch of claim 2, further comprising a port, at least one optical transmitter and at least one optical receiver connected to the protocol processor, the optical blockers connected to the at least one optical transmitter and to the at least one optical receiver, an optical filter connected to the optical blocker of the optical transmitter, a demultiplexer connected to the optical blockers of the optical receivers, and a passive optical star connected to the optical filter and to the demultiplexer.

4. The physical layer protocol switch of claim 2, wherein at least one of the topologies is a computing logical system topology that allocates computing subsystem resources.

5. The physical layer protocol switch of claim 2, wherein the configuration policy manager and controller includes a plurality of function modules, the function modules comprise a topology policy library module containing the topology library, a failover control module, a diagnostics module, an external management and control interface module, an audit function module, an optical transmit function control module, and an optical receive function control module.

6. A photonic protocol switch system, comprising:
a photonic protocol switch;
a plurality of computing subsystem resources linked to the photonic protocol switch; and
the photonic protocol switch includes a configuration policy manager and controller connected thereto that manages and controls the photonic protocol switch, the configuration policy manager and controller has a topology library having a database containing a list of approved computing subsystem resource topologies.

7. The photonic protocol switch system of claim 6, wherein the photonic protocol switch comprises a port, a protocol processor connected to the port, at least one optical transmitter and a plurality of optical receivers connected to the distributed Ethernet switch, optical blockers connected to the optical transmitter and to the optical receivers, an optical filter connected to the optical blocker of the optical transmitter, a demultiplexer connected to the optical blockers of the optical receivers, and a passive optical star connected to the optical filter and to the demultiplexer.

8. The photonic protocol switch system of claim 6, wherein the configuration policy manager and controller includes a plurality of function modules, the function modules comprise a topology policy library module containing the topology library, a failover control module, a diagnostics module, an external management and control interface module, an audit function module, an optical transmit function control module, and an optical receive function control module.

9. The photonic protocol switch system of claim 6, wherein the computing subsystem resources comprise at least two of the following: sensors, communications devices, down graders, processors, storage devices, printers, displays, network switches, servers, workstations, scanners, personal computers, and/or voice over IP systems and guards.

10. The photonic protocol switch system of claim 6, wherein the computing subsystem resources are connected to the photonic protocol switch by a wired connection or a wireless connection.

11. A method comprising:
configuring a system that includes a physical layer photonic protocol switch and a plurality of computing subsystem resources connected to the physical layer photonic protocol switch, and a configuration policy manager and controller, having a topology library with a plurality of computing logical system topologies, that is connected to the physical layer photonic protocol switch; and
configuring the configuration policy manager and controller to control and manage allocation of at least one of the computing subsystem resources to a requesting computing logical system topology via the physical layer photonic protocol switch.

12. The method of claim 11, further comprising configuring the configuration policy manager and controller to check the availability of the computing subsystem resources for possible allocation.

13. The method of claim 11, wherein each computing logical system topology includes a plurality of the computing subsystem resources wherein when one of the computing logical system topologies is selected, the corresponding plurality of computing subsystem resources are allocated to the selected computing logical system topology.

14. The method of claim 11, wherein the computing subsystem resources comprise at least two of the following: sensors, communications devices, down graders, processors, storage devices, printers, displays, network switches, servers, workstations, scanners, personal computers, and/or voice over IP systems and guards.

15. The method of claim 11, wherein the computing subsystem resources are connected to the physical layer photonic protocol switch by a wired connection or a wireless connection.
